(19) United States
(12) Patent Application Publication
(10) Pub. No.: US 2013/0068173 A1
(43) Pub. Date: Mar. 21, 2013

(54) INTERNET COMMUNICATION SYSTEM FOR PETS

(71) Applicants: George R. Jamison, (US); Caleb Chung, (US)

(72) Inventors: George R. Jamison, (US); Caleb Chung, (US)

(21) Appl. No.: 13/612,350

(22) Filed: Sep. 12, 2012

Related U.S. Application Data
(60) Provisional application No. 61/533,682, filed on Sep. 12, 2011.
(60) Provisional application No. 61/534,207, filed on Sep. 13, 2011.

(51) Int. Cl. A01K 15/02

(52) U.S. Cl. CPC A01K 15/025
USPC 119/707

(57) ABSTRACT

A system for remote interaction with a pet is provided which may include a home computer connected to a movable turret. The turret has rotary components driven by a servo-motors to direct a laser to the floor to create shapes depending on the play to be performed, such as images on the floor or lines defining various shapes that may be shifted, contorted, or changed in shape to amuse a pet. The user can position, rotate and scale the shaped path within the environment provided by the floor area and can control the animation speed, play and pause as well as set the apparatus in a play mode to loop forward and backward through a shaped path. Video and audio including the pet owner's voice may be introduced to further entertain the pet while he or she is home alone.

### CROSS-REFERENCE TO RELATED APPLICATIONS

This application claims the benefit of co-pending application Ser. Nos. 61/533,682, filed on Sep. 12, 2011, and 61/534,207, filed on Sep. 13, 2011, both entitled INTERNET COMMUNICATION SYSTEM FOR PETS.

### FIELD

This invention relates to a system which monitors a household pet while the owner is away and links the owner's location and the pet's location via the internet, and enables the owner to also play with the pet from a remote location.

### BACKGROUND

Many home owners have pets, usually one or more dogs or cats, which become part of the household on a day-to-day basis. Caring for a pet, however, is a problem when the owner leaves for a protracted period and thus may be gone for several days or more. When this occurs the pet is typically boarded at a kennel away from his or her usual environment, and oftentimes confined such that movement and its normal activities are restricted. Accordingly, the kennel is less than desirable for most pet owners, but is typically the only alternative when away from home.

Furthermore, the alternative of leaving a pet in its home environment is also not desirable as the pet may receive little or no attention and be simply confined within the home without enjoying normal activity. This is a frustration both to the pet and to the pet owner. Accordingly, it would be desirable to provide a means of communicating with a pet or pets that are left at home so that they may enjoy their normal environment while the owner is away.

### SUMMARY

In an embodiment of the present invention the aforementioned problem is addressed by providing a play area or location within the home where the pet is kept while the owner is away. The pet's location is linked via the internet (or telephone lines as an alternative) to the owner's location remote from the home, which may be where the owner or owners are on vacation, visiting friends, or conducting business. To play with the pet, a laser moves as commanded by the owner from a remote computer terminal to locations within a video area that defines a play area for the pet. The laser moves to coordinates as commanded from the owner's remote interface to entertain the pet by providing a play mode in which animation settings are defined on the floor to amuse the pet. For example, one animation setting would be a random loop on the floor as if a yo-yo were lying there. Another example is a play mode that may define various animation settings comprising geometric figures on the floor such as a circle, a star, and straight and curved lines of various shapes. These images may be moved and adjusted from the owner's location to amuse the pet. Therefore, the pet can play as if the owner were at home to the satisfaction of both the pet and the owner who is watching from the remote terminal.

A pleasant environment for a pet while the owner is away from home is provided by an interactive communication system including a host computer linked via the internet to a remote device or computer where the pet owner can command the laser depending upon the type of interaction and/or play that the user wishes. The commands can be verbal or remotely controlled via the laser depending upon the type of interaction and/or play that the user wishes to initiate.

The home computer may be connected to and command a movable turret standing upright on the floor or hanging on a wall in the room where the pet is kept. The turret has rotary components driven by a servo-motor to direct a laser to the floor to create shapes depending on the play to be performed, such as images on the floor or lines defining various shapes such as a yo-yo loop, or other linear pattern that may be shifted, contorted, or changed in shape to amuse a playful pet. Additionally, figures may be defined such as circles, stars, and other patterns that appear on the floor to amuse the pet who may “play” with one figure, then see it quickly change to another, and then another, etc. The user can position, rotate and scale the shaped path within the environment provided by the floor area and can control the animation speed, play and pause as well as set the apparatus in a play mode to loop forward and backward through a shaped path. Video and audio including the pet owner's voice may be introduced to further entertain the pet while he or she is home alone.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 illustrates primary components at the owner's location, the intermediary server, and components at the pet's location, and includes supporting data.

FIG. 1A is a diagram showing laser calibration of FIG. 1.

FIG. 1B is a diagram showing laser function of FIG. 1.

FIG. 1C illustrates camera control of FIG. 1.

FIG. 2 is a block diagram showing the various components of the system of the present invention and data flow.

FIG. 3 shows various views of the camera/laser/speaker/mic turret instrument employed at the pet's location.

FIG. 4 is an exploded view of the turret.

FIG. 5 is an exploded view of the camera module and associated components of FIG. 4.

FIG. 6 is an exploded view of the laser module of FIG. 4.

FIG. 7 is an exploded view of the speaker module of FIG. 4.

FIG. 8 is an exploded view of the driver module of FIG. 4.

FIG. 9 is a view of a living area of a home in which a pet may live and play, and illustrates calibration.

FIG. 10 is a view similar to FIG. 8 with the image of an enclosed circle added to define a play area.

FIG. 11 is a view similar to FIG. 9 showing, a random looped line on the floor for the amusement of the pet.

FIG. 12 illustrates setup of the system to connect remotely.

FIG. 13 illustrates the audio setup of the system.

FIG. 14 illustrates the video setup of the system.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable or preferred for a given purpose in connection with the invention implies that mixtures or combinations of any two or more members of the group or class may be equally suitable or preferred.

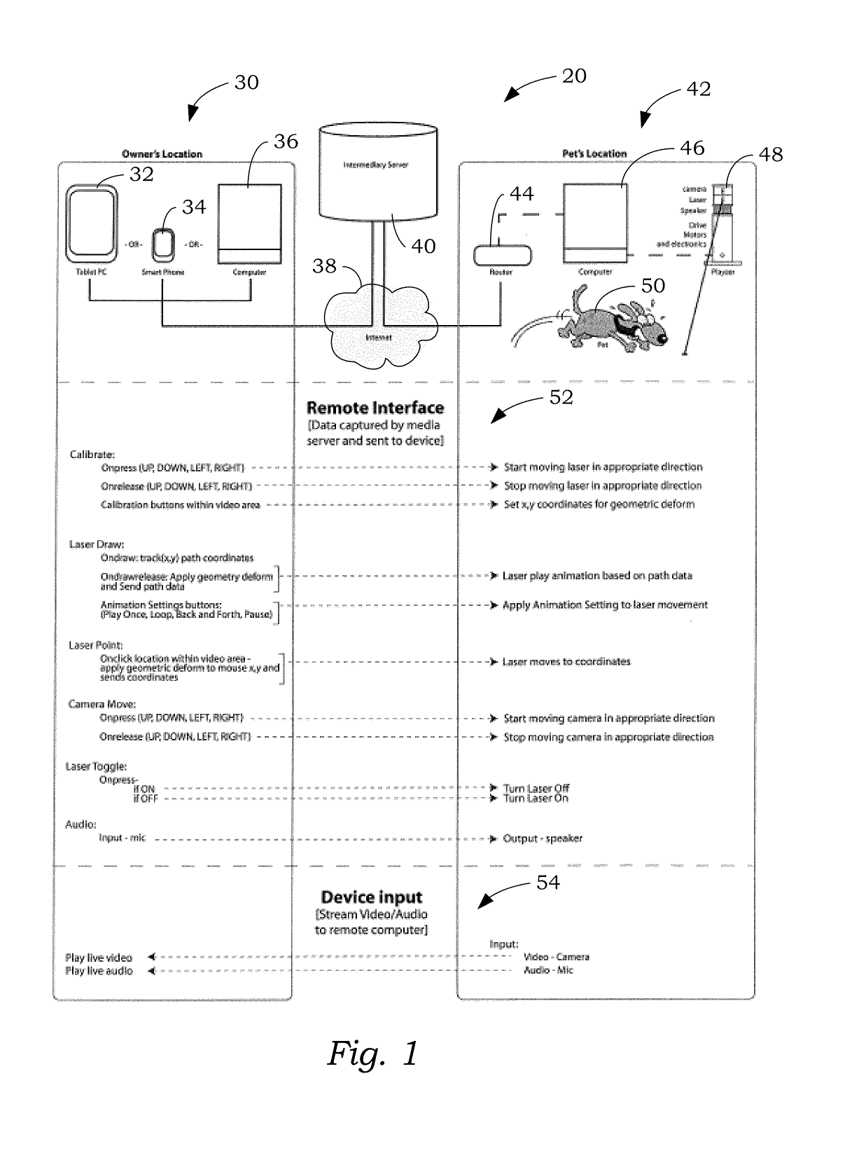

Referring initially to FIG. 1, primary components of the interactive communication system are generally indicated by reference numeral 20. The interactive communication system 20 includes a remote computer 30, such as a tablet personal computer 32, smart phone 34 or a desktop computer 36 at the owner's location away from home, such as at work or at a vacation site. Output is connected via the internet 38 and an intermediary server 40 to receiving equipment at the pet owner's home 42. Components of the receiving equipment include a router 44, a host computer 46, such as a personal computer, and a turret 48 (described in detail below). Specifically, the receiving equipment is located in a room such as a family room in which the pet 50 typically plays. In summary, output from the host computer 30 is delivered via the internet 38 to the intermediary server 40 and ultimately delivered to the home 42 at a room therein which may, for example, be where the pet (or pets) plays. Calibrate, laser draw, laser point, camera move, laser toggle and audio and the resulting output are summarized in the remote interface and device input listing 52 and device input 54. The interface 54 shows video and audio input streamed to a remote computer and, via the internet, delivered to the remote interface software at a desired location in the home where live video and live audio are played.

The camera and microphone to be discussed hereinbelow stream video and audio via the home server to the remote computer where live video and audio is seen and heard by the pet owner who may thus both visually and audibly monitor and enjoy the actions of the pet.

From the remote computer 30, the user may interface with the local computer 46 to setup and control the turret 48 using a variety of the commands 52. For example, the user may calibrate the device laser for a certain room in the housing by setting the X and Y coordinates for a particular area (FIG. 1A). The user may set up and store a path to be played once, looped or played back and forth, for example. The user may move a cursor to a location and select the location commanding the laser at the pet's location 42 to point to that location and turn on or off (FIG. 1B). The user may remotely command a camera to move (FIG. 1C). The user may also turn on the remote mic to be transmitted to an output speaker at the pet's location 42.

The remote device or computer 30 and intermediary server 40, the home computer 46, and turret 48 (as will be set forth fully hereinbelow) comprising a turret housing a camera, a laser, a speaker, and a microphone to allow the owner to communicate or interface with the pet. The connection from the computer 30 which accompanies the pet owner at a remote location is thus directly connected with the home computer 46 via the intermediate server 40 and the internet 38 as illustrated. Accordingly, as will be discussed more fully hereinbelow, the pet owner is able to play with and amuse the pet while he or she is away from home. It should be understood that the host computer 46 may be integrated into the turret 48 and not a separate device.

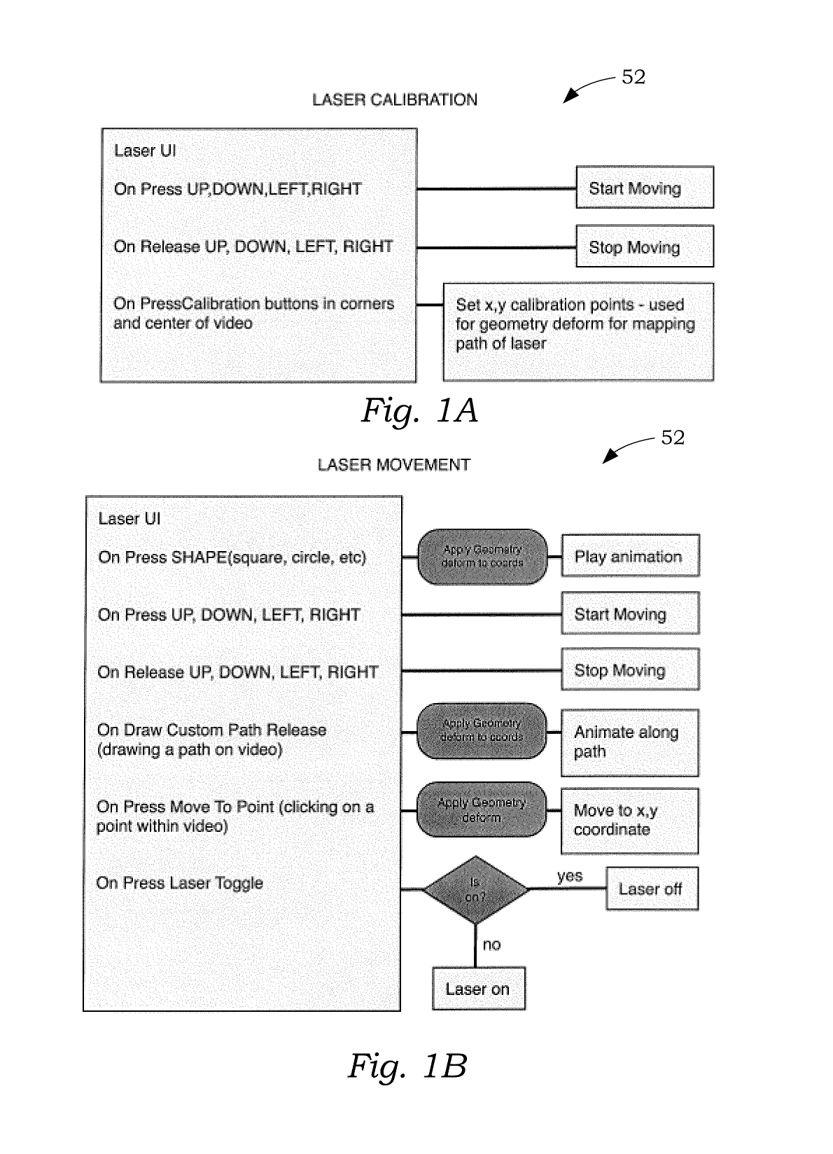

The block diagram of FIG. 2 shows the system components and their interconnection. A controller 46 employs an open source Java-based flash media server (Red5). In response to the controller 46, a bridge 66 comprises a Java library and controls the servos (discussed below) that move a laser left and right, and a camera left and right, up and down, all of which are part of the turret 48.

Communication is initiated via the internet 38 connected to a router 44 via a forward TCP port 70. TCP 1936 (71) and TCP 1935 (73) are exemplary port numbers by which communication to controller 46 may be established. Red5 is an open source Java-based media server for video, audio and in accordance with control data. Output is delivered to a bridge 66 comprising a Java library that controls the turret hardware 48. Although the preferred user interface 30 is via the internet, a local user interface 72 and an optional intranet interface is shown at 74.

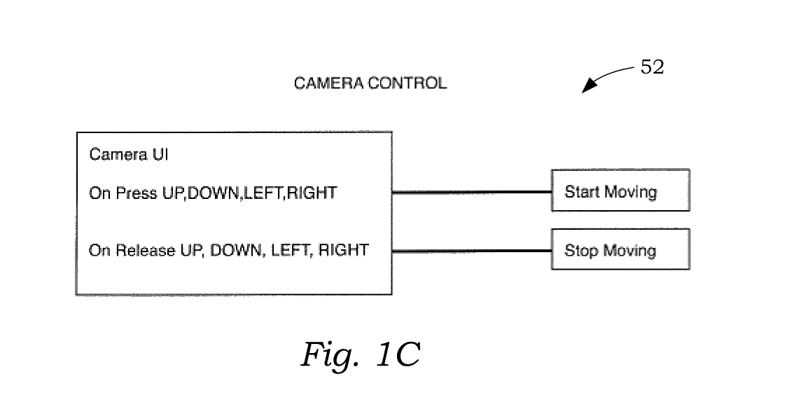

Referring to FIG. 3, the turret 48 is shown in detail and is employed at the pet's location under the command of the user at the remote location. Turret 48 includes a camera port 82, a laser port 84, and a speaker section 104 that permits a speaker in the turret to be heard by the pet in response to the owner's voice from the remote location. A plurality of openings 88 near the base of the turret 48 receives the voice of the pet. On the back side of the turret 48, a wall mount 90 and USB port 92 are provided for mounting and electrical connections. A top view of the turret and an associated exemplary wall mount bracket 94 are also shown. Connections to the turret 48 are via a USB cable or wirelessly.

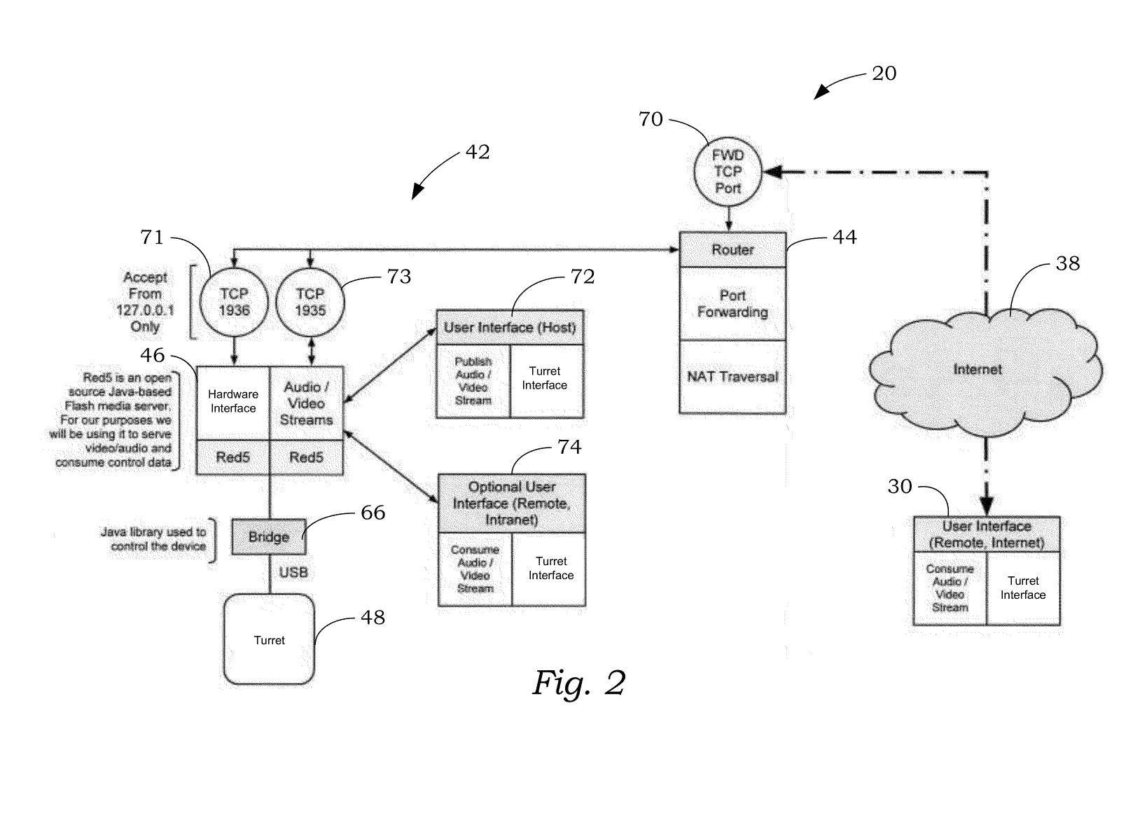

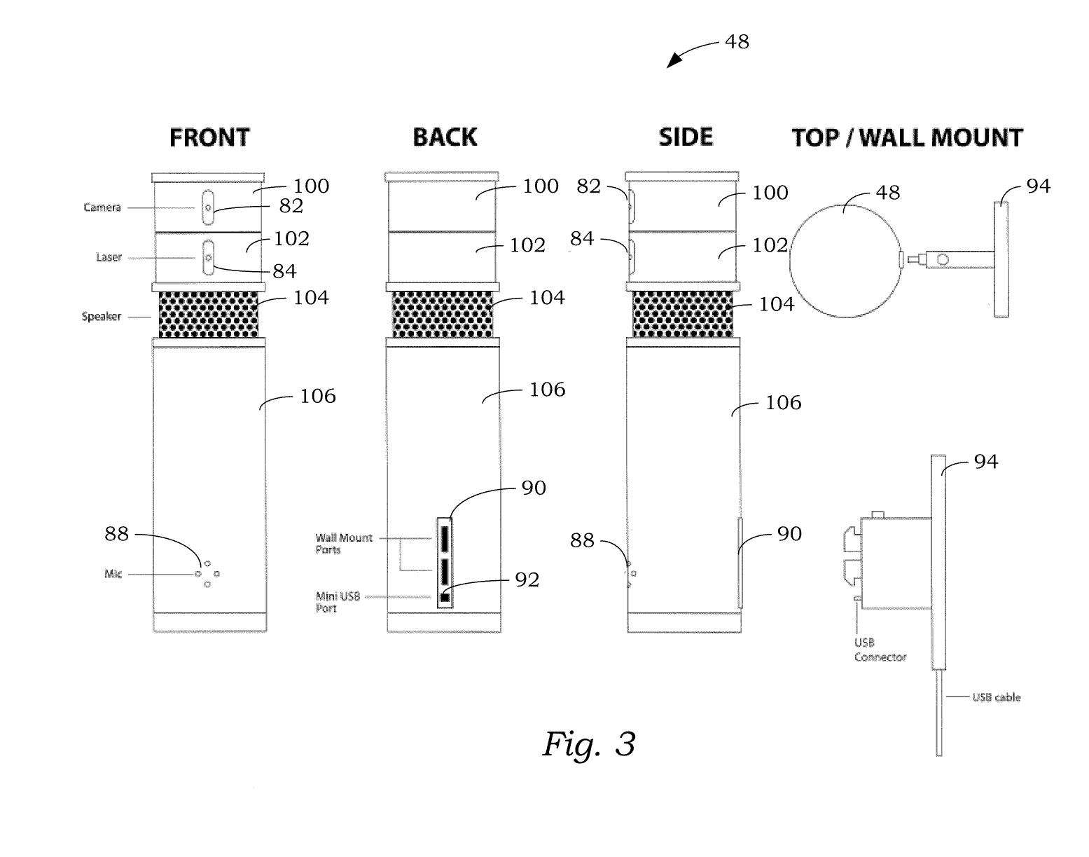

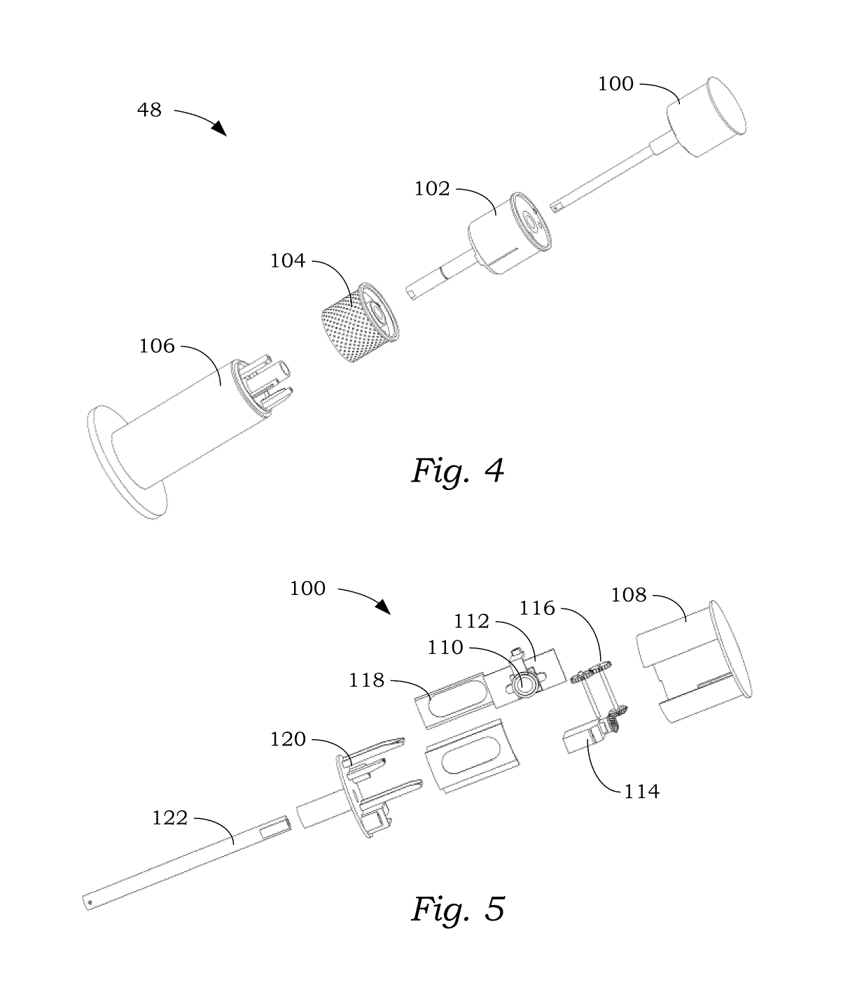

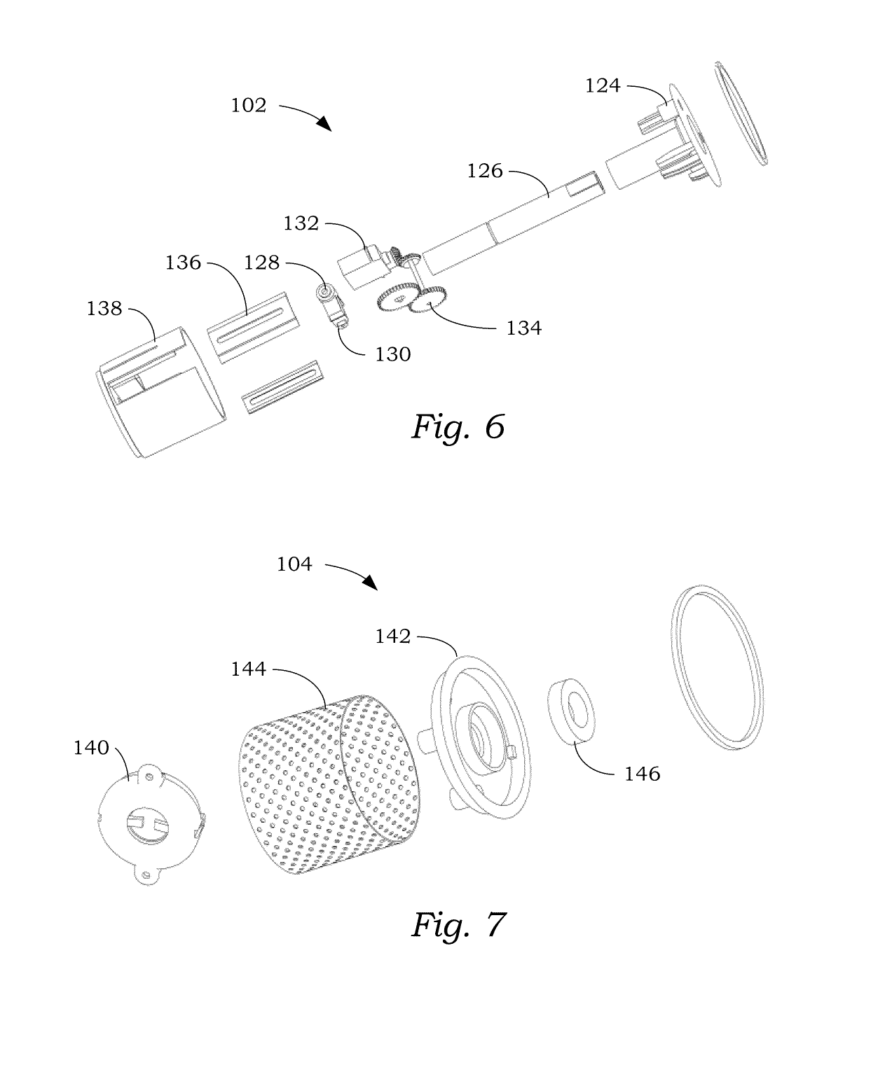

Referring to FIGS. 4-8, the turret 48 includes a camera module 100, a laser module 102, a speaker module 104 and a base driver module 106. The camera module 100 includes a top cover 108, a camera 110, a camera mount 112 coupled to a servo motor 114 and gears 116, a lens cover 118, a camera module housing bottom 120, and a camera module rotation shaft 122. The camera 110 is mounted to the camera mount 112, which is rotatably mounted to the gears 116, which are driven by the servo motor 114. The servo motor 114 is responsive to position commands 52 received from the remote computer 30 to rotate the camera 110 about a horizontal x-axis to point the camera 110 up and down. The camera 110 is positioned behind the lens cover 118, which protects the camera 110 from dirt and debris. All of these components are secured to the camera module housing bottom 120 within the top cover 108, and the camera module housing bottom 120 is mounted on the camera module rotation shaft 122.

The laser module 102 includes a laser housing top 124, a laser module rotation shaft 126, a laser 128 secured to a laser mount 130 coupled to a servo motor 132 and gears 134, a transparent laser cover 136, and a laser housing bottom 138. The laser 128 is mounted to the laser mount 130, which is rotatably mounted to the gears 134, which are driven by servo motor 132. The servo motor 132 is responsive to position commands 52 received from remote computer 30 to rotate the laser 128 about a horizontal x-axis to point the laser 128 up and down. The laser 128 is positioned behind the transparent lens cover 136, which protects the laser 128 from dirt and debris. All of these components are secured with in the laser housing bottom 138, which is mounted on the laser module rotation shaft 126.

The speaker module 104 includes a speaker 140 mounted to a cover 142 behind a speaker grill 144 and a bearing 146 to support laser mount rotation shaft 126 which passes through the speaker module 104 into the base driver module 106.

The base driver module 106 includes a base 148, a base mount 150, a base cover 152, a boss pin 154, a printed circuit board 156, a camera module rotation motor 158, a laser module rotation motor 160, and a base top 162. The camera module rotation motor 158 is coupled to the camera module 100 in a horizontal plane about the vertical y-axis. The printed circuit board 156 is mounted to the boss pin 154 and includes a microprocessor, USB interface, memory, and servo motor interfaces. All of these components are mounted within the base housing 152. The PCB 156 may also include a wireless interface such as Wi-Fi (802.11x), Bluetooth® or cellular, for example, to wirelessly communicate through a local area network or cellular network to the remote device 30.

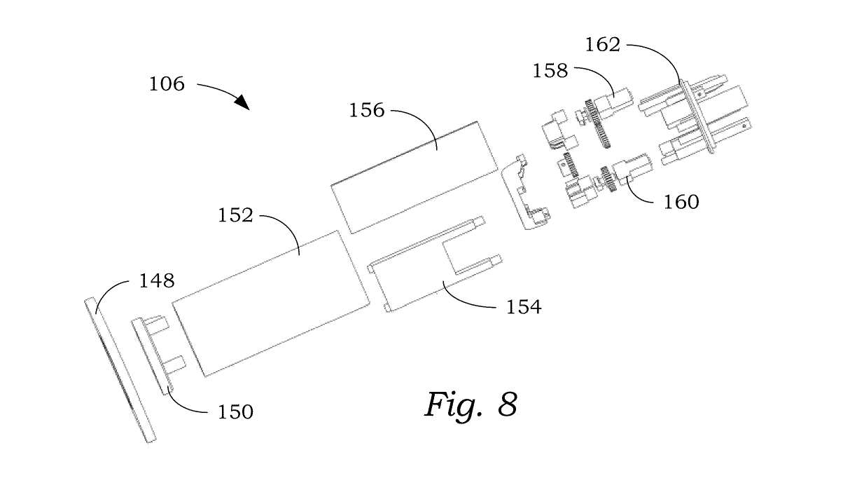

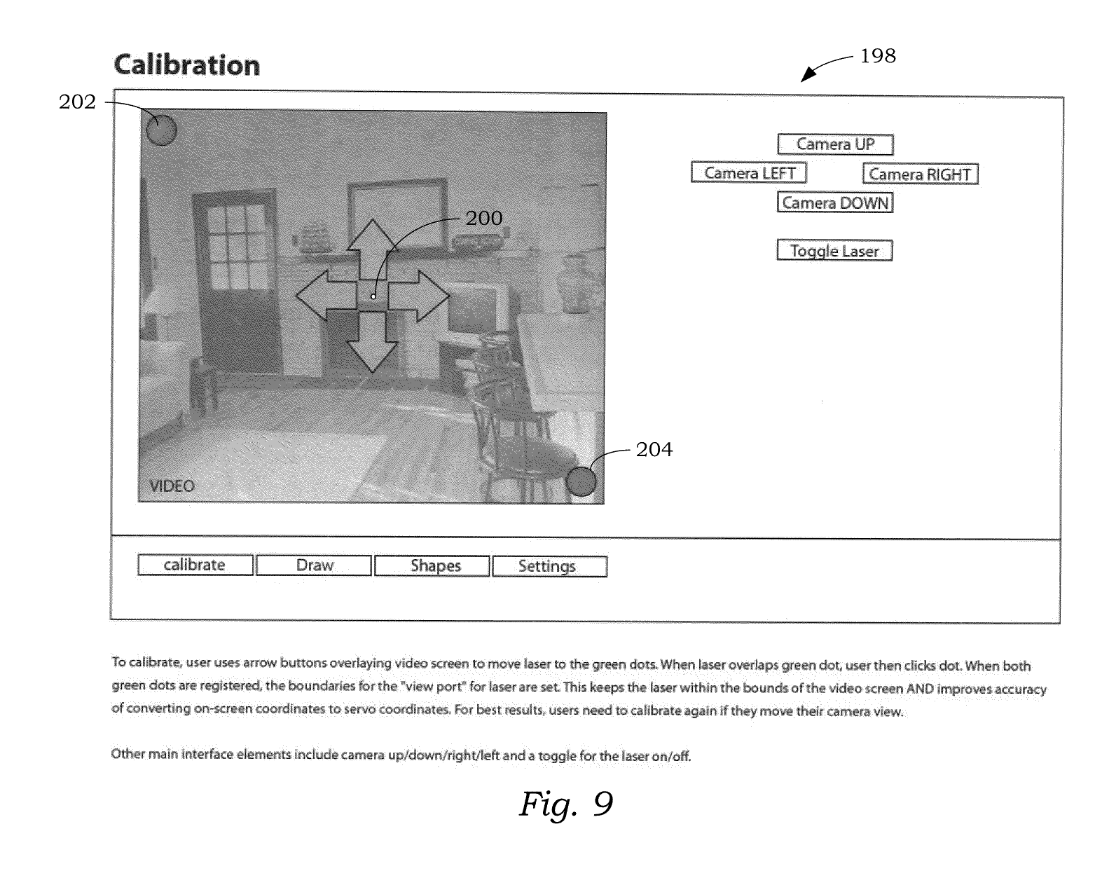

Referring to FIG. 9, the user at the remote location uses arrow buttons overlying a video screen 198 to calibrate or define the limits of the laser window. The user uses the arrow keys to move the laser 200 to an upper dot 202 and a lower dot 204. When the laser 200 overlaps the dot the user then clicks the dot. When both dots 202 and 204 are registered, the boundaries for the viewport for the laser 200 are set. The laser 200 is thereby kept within the bounds of the video screen and improves accuracy in converting on-screen coordinates to servo coordinates. As may be appreciated from FIG. 8 the dots 202 and 204 define the main portion of a room within which the pet will play, the central portion of which constitutes a floor area presenting such play area.

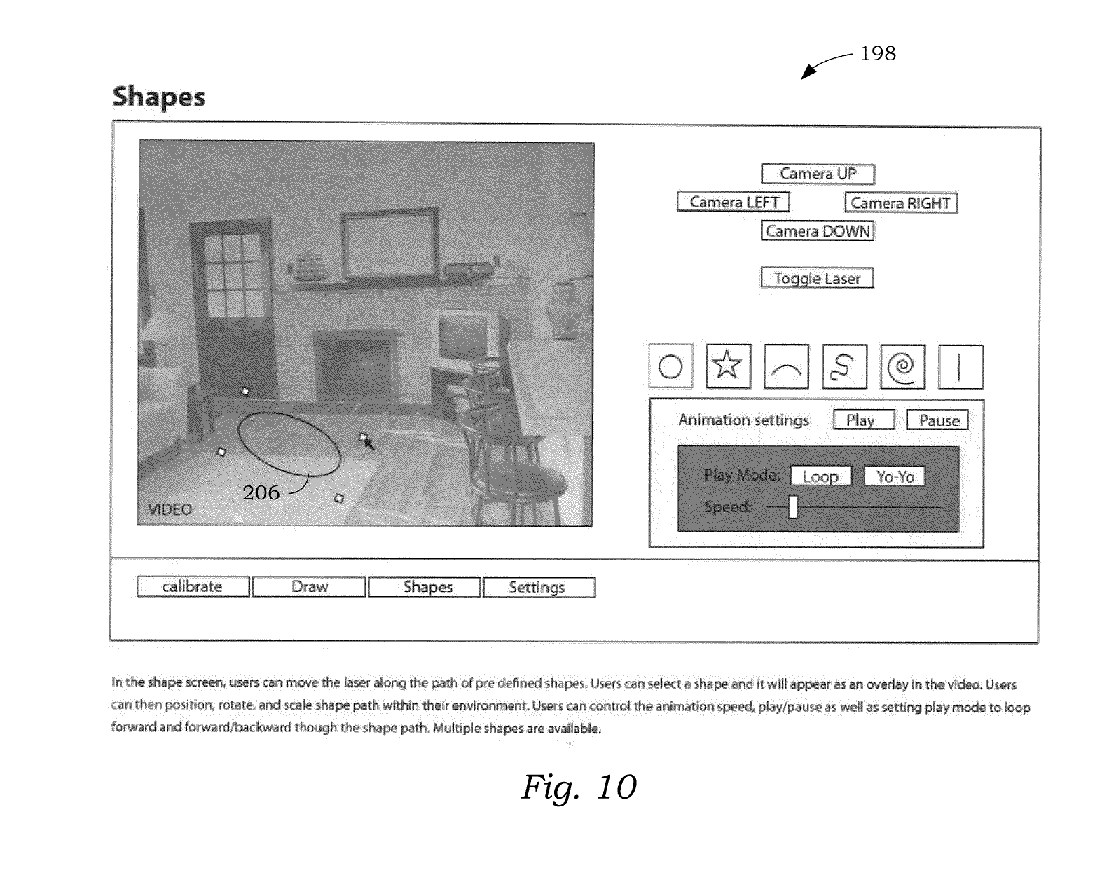

FIG. 10 illustrates exemplary animation settings such as a circle 206 when entered on the floor, although it may be appreciated that other shapes may be defined such as a star, a curve, and an irregular line, a spiral and a straight line.

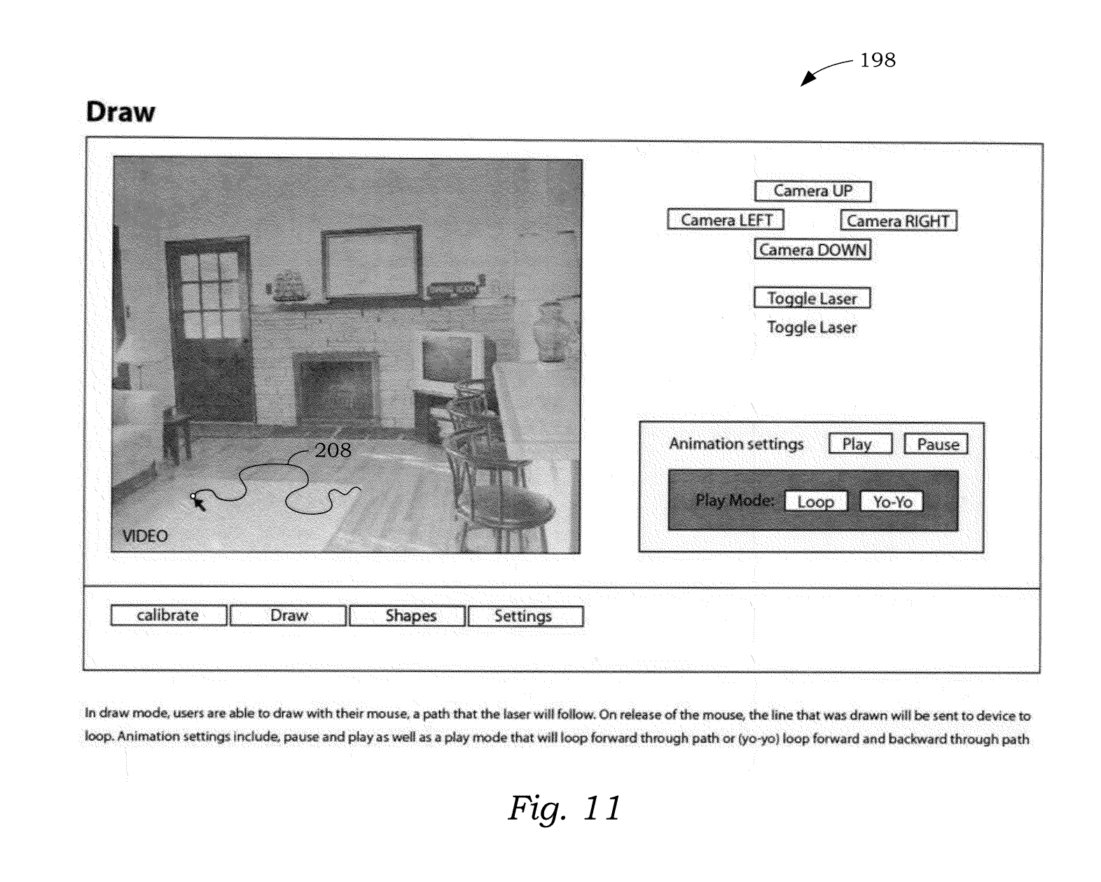

FIG. 11 illustrates another loop of a random form 208 to amuse the pet. Accordingly, it may be appreciated that any of the animation settings may be employed and sequenced in a desire to keep the pet active and entertained.

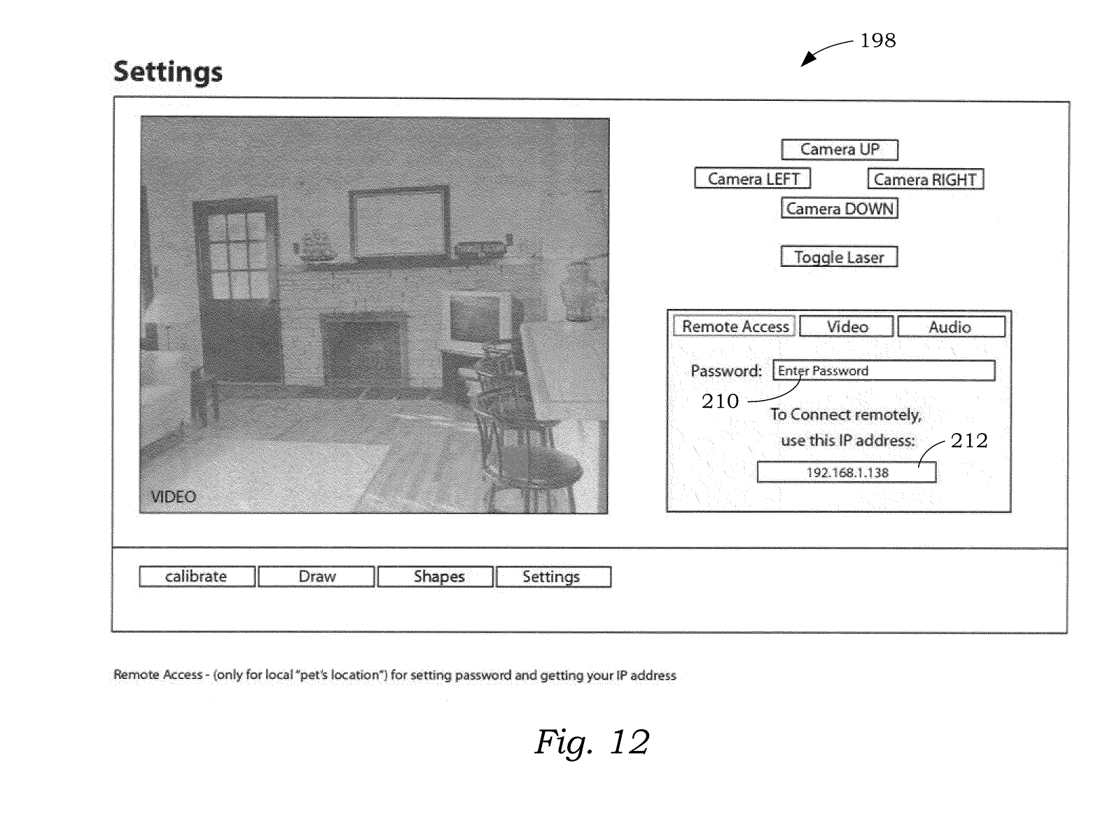

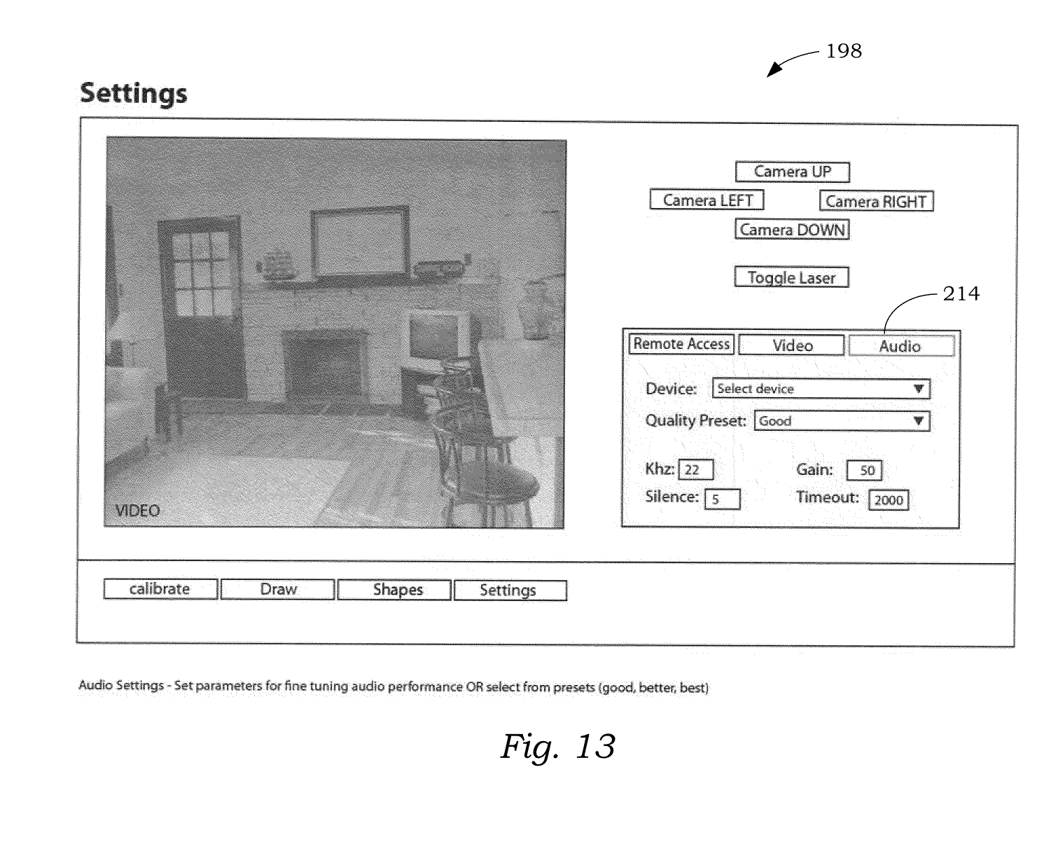

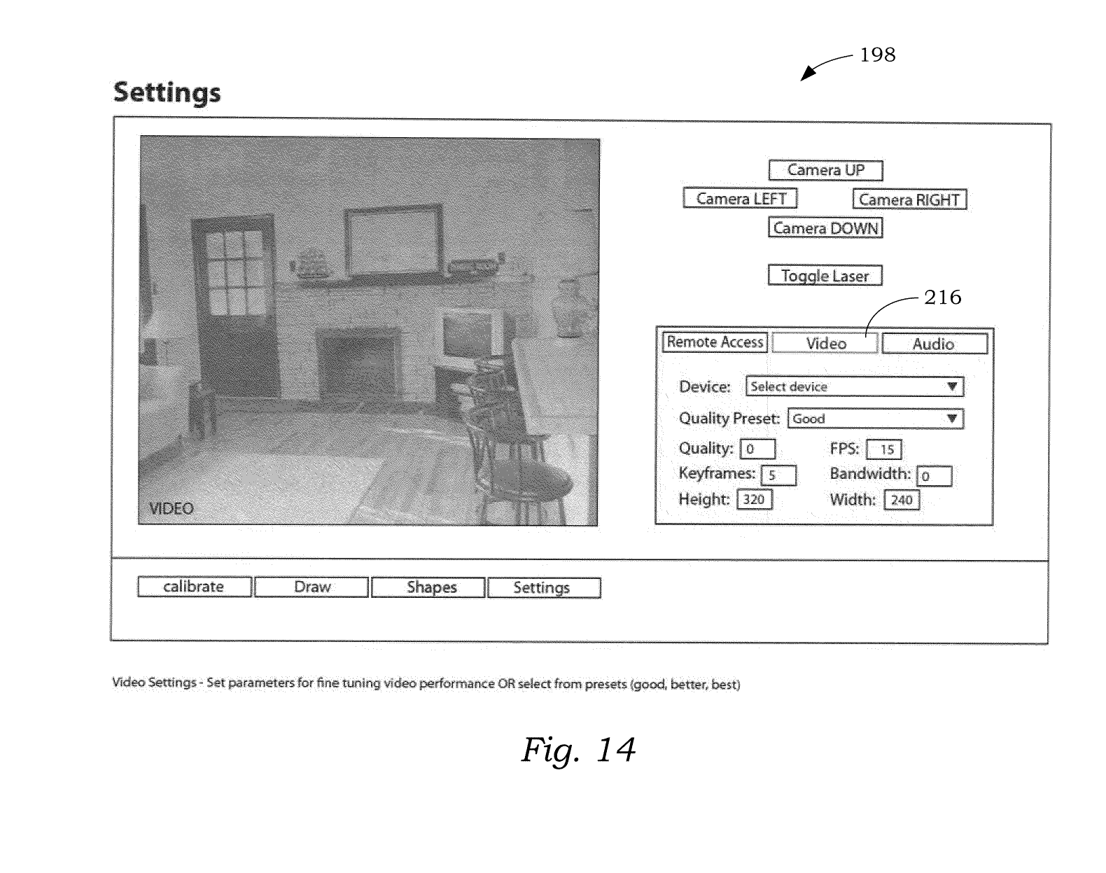

The settings necessary to activate the system from the remote location are illustrated in FIGS. 12-14. Steps involved are, for example, entering the user's password 210, entering an IP address 212 of the device, selecting the audio settings 214 of the device, and the video settings 216 of the device. In amusing the pet, it will be appreciated that camera and laser turret are controlled by the user from the remote location to see the pet in action, broadcast the user's voice over the speaker 140, and listen to the sounds of the pet via the microphone 88. Accordingly, a two-way communication is established for the delight of both the owner and his or her pet. Using the wireless capabilities of the system, the user may activate other wireless capable systems such as a pet door, a bowl feeder, a remote toy or other accessories, for example.

An exemplary set of commands have been implemented in the Java bridge library that can be called from the user interface, which may be written in Adobe flash. The Java bridge may include a combination of the following three classes:

1) Red5Device—The highest level class that controls the LazerDevice and contains all the commands that are made available for the user interface to call.

2) Device—The middle tier class that gets called by Red5Device. The Device class is an extension of the lowest level class called Pololu. This class handles configuration and management of files related to the LazerDevice (saved calibrations and video, for example). It also keeps track of laser and camera position, calibration points that define the boundaries of the camera viewport, and coordinate pair values for a currently defined drawing. It can start a drawing in motion by spawning a separate thread of control which remains active until the drawing is either manually stopped by the user (as in the case of “Loop” or “Yoyo” drawing mode), or when a drawing in “single” mode reaches the last coordinate point.

3) Pololu—The lowest level class. This class issues commands to the Pololu Micro Maestro servo controller in the format that the controller expects. Some commands return values that are then passed back up to the Device class.

An exemplary set of LazerDevice commands are included below for control of the laser turret 48.

deleteNamedCalibration(String name)—Deletes a named calibration by deleing the file associated with it. [Can raise an IOException under a couple circumstances (file not found, unable to delete file).]

deleteVideoRecording(String name)—Deletes a video-file and its associated thumbnail file.

getCurrentDrawingState( )—Returns a boolean value indicating whether or not a drawing is currently being played (true=drawing is being played, false=drawing is not being played). The definition of a drawing being played is a when the laser beam is actively moving along a saved set of coordinates thereby “drawing” a path with laser light.

getCurrentLaserState( )—Returns a boolean value indicating whether the laser is turned on (true) or off (false).

getNamedCalibrationList( )—Returns a string of pipe-delimited (“|”) calibration names. The pipe symbol is being used in order to allow other more common delimiters (such as commas) to be used the calibration names without causing problems. Returns an empty string if there are no existing named calibrations that have been saved.

getNewClientID( )—Returns the client ID that has been assigned to a newly connected user interface. Every time the user interface program is run and makes a connection to the Red5Device server, it is issued a unique client ID which the server uses to keep track of which client is actively in control of the device. Chat functionality between clients is also made possible using the client IDs, though chatting has not been implemented yet.

getVideoRecordingList( )—Returns an array of strings, each delimited by a pipe (“|”). Each element of the array is for a single filename/thumbnail combination. Thumbnail data is given as a Base64 encoded string. If a video file doesn't have an associated thumbnail for whatever reason, then the thumbnail portion of the value will be empty after the pipe symbol.

loadNamedCalibration(String name)—Loads a previously saved named calibration set and applies the calibration settings to the LazerDevice. [Can raise an IOException under several different circumstances (file not found, unable to open file, file contains invalid data).]

renameVideoRecording(String oldName, String newName, boolean overwrite)—Renames an existing video file from oldName to newName. If a video file already exists under the newName, passing a value of true for the overwrite parameter will cause it to be overwritten, otherwise an error message will be sent back via message type “renameVideoRecording.” The associated thumbnail file will automatically be renamed at the same time if renaming the video file succeeds.

requestControl(String clientID)—Requests that the client in control of the LazerDevice be switched to the client ID being passed in via the clientID parameter. If the clientID is valid, control is immediately switched to this new client.

resetDevice( )—Resets the LazerDevice back to its startup condition.

saveNamedCalibration(String name, boolean overwrite)—saves current calibration settings under a given name. The overwrite parameter allows for overwriting an existing saved calibration set. [Raises an exception called NamedCalibrationAlreadyExists if the overwrite parameter is set to false and the name already exists. Can also raise an IOException if there is any problem saving the calibration file.]

saveVideoRecording(String saveName, String pngThumbnailBase64String, boolean overwrite)—Renames the temporary video file recorded from the last call of startRecordingVideo giving it the name passed in via the saveName parameter. The pngThumbnailBase64String parameter should be populated with a Base64 encoded string containing the thumbnail in .png format. This will be saved under the same name as the saveName parameter but with a “.png” extension. If the video file already exists, passing a value of true for the overwrite parameter will cause it to be overwritten, otherwise an exception will be raised.

sendMessageToAllFlashClients(string msgType, String msg)—Sends a message of type msgType to all flash clients. The details of the message are given by the msg parameter. This allows for communication between all connected flash clients (i.e., all running user interface programs that are connected to the Red5Device application on the Red5 server which is running on the Host machine).

setCalibrationPoint(string pointName, int flashX, int flashY)—Sets the coordinates of the named point, for example “UPPER_LEFT” or “LOWER_RIGHT,” to those passed in via the flashX and flashY parameters. This associates the given flash coordinate position with the current laser servo X and Y values. [Raises an exception called InvalidCalibrationPointNameException if any other calibration point name is passed in.]

setDrawing(string pointPairs, boolean is FreehandDrawing)—Defines laser path coordinates for the drawing feature. PointPairs is a string containing comma separated X, Y pairs and each pair is separated from the next by a pipe (“|”) symbol. If the drawing is set with is FreehandDrawing=true, then the interval between pairs is set at exactly 33 milliseconds to account for our flash movie capture rate of 30 fps. Otherwise the speed of the drawing playback will be determined by the speed parameter passed via the startDrawing method.

setLaser(boolean mode)—Turns the laser beam on or off.

setLaserLocation(int x, int y, int speed)—Move the laser to a new location. The speed parameter defines how quickly this happens. An empty or 0 value for speed causes it to default to as quickly as possible, otherwise a suggested valid range of speeds is from 1 to 100. The Pololu Maestro appears to be capable of accepting speed values up to 10000, but above 100 they all seem to be about the same speed anyway (no noticeable difference to the human eye).

setLaserToCenter(int speed)—Moves the laser to the center of the calibrated viewport at the given speed.

startCameraDown(int speed)—Starts moving the camera vertically downward at the given speed.

startCameraLeft(int speed)—Starts moving the camera horizontally to the left at the given speed.

startCameraRight(int speed)—Starts moving the camera horizontally to the right at the given speed.

startCameraUp(int speed)—Starts moving the camera vertically upward at the given speed.

startDrawing(String mode, int speed)—Starts the drawing last sent via setDrawing into motion. If called after stopDrawing, without calling setDrawing again, this will resume the previous drawing from the stopped position, otherwise it will start from the first coordinate. The mode can be one of three values: “SINGLE” (play once, which is the default), “LOOP” (keep drawing the path over and over), or “YoYo” (draw the path forward, then backward, repeat). The speed can only be set for non-freehand drawings, otherwise it is ignored. This method can also be called with just a mode parameter (i.e., startDrawing(String mode)) or with no parameters at all (i.e., startDrawing( )). [Raises an exception called InvalidDrawingModeNameException if the mode passed in is anything but the accepted three.]

startLaserDown(int speed)—Starts moving the laser vertically downward at the given speed.

startLaserLeft(int speed)—Starts moving the laser horizontally to the left at the given speed.

startLaserRight(int speed)—Starts moving the laser horizontally to the right at the given speed.

startLaserUp(int speed)—Starts moving the laser vertically upward at the given speed.

startRecordingVideo( )—Begins saving the current video stream to a temporary file. If a prior temporary file exists, it will be deleted before the new recording begins.

stopCamera( )—Stop moving the camera in any direction.

stopDrawing( )—Stops the drawing if it is actively playing. Actually, in effect it pauses the drawing until resumed with startDrawing, or is reset with setDrawing.

stopLaser( )—Stop moving the laser in any direction.

stopRecordingVideo( )—Stops saving the current video stream.

It is to be understood that while certain now preferred forms of this invention have been illustrated and described, it is not limited thereto except insofar as such limitations are included in the following claims.

Having thus described the invention, what is claimed as new and desired to be secured by Letters Patent is as follows:

1. A computer based system for communicating with a pet from a remote location, said system comprising:
a host computer,
a turret positioned at a desired location where the pet may play and in communication with said host computer, said turret housing a camera, a laser, a speaker, and a microphone to establish two-way communication between the owner and the pet,
a remote computer located at said remote location away from said desired location for establishing an information exchange between said host and remote computers and said turret thereby enabling the pet owner to operate said turret and play with and amuse the pet while the pet owner is away from said desired location, and
said remote computer being operable to define the limits of a laser window within the bounds of a video screen of the remote computer, establish limits on said video screen defining a portion of said desired location within which the pet may play, and define a shape of said portion of the desired location.

2. The computer based system of claim 1 wherein said laser is coupled to a motor responsive to commands received from said remote computer to rotate said laser about a horizontal axis.

3. The computer based system of claim 1 wherein said laser is coupled to a motor responsive to commands received from said remote computer to rotate said laser about a vertical axis.

4. The computer based system of claim 1 wherein said camera is coupled to a motor responsive to commands received from said remote computer to rotate said laser about a horizontal axis.

5. The computer based system of claim 1 wherein said camera is coupled to a motor responsive to commands received from said remote computer to rotate said laser about a vertical axis.

6. The computer based system of claim 1 wherein said laser is coupled to a first motor responsive to commands received from said remote computer to rotate said laser about a horizontal axis, and wherein said laser is coupled to a second motor responsive to commands received from said remote computer to rotate said laser about a vertical axis.

7. A method of communicating with a pet from a remote location, said method comprising:
providing a host computer at a desired location where the pet may play,
providing a camera, a laser, a speaker and a microphone at said desired location,
providing a remote computer away from said desired location, and
establishing a two-way communication between said host and remote computers via the internet to provide information exchange between said host and remote computers to enable the pet owner to play with and amuse the pet.

8. The method of claim 7 further comprising said host computer responsive to receiving information from said remote computer to rotate said laser about a horizontal axis.

9. The method of claim 7 further comprising said host computer responsive to receiving information from said remote computer to rotate said laser about a vertical axis.

10. The method of claim 7 further comprising said host computer responsive to receiving information from said remote computer to rotate said camera about a horizontal axis.

11. The method of claim 7 further comprising said host computer responsive to receiving information from said remote computer to rotate said camera about a vertical axis.
